(19) United States
(12) Patent Application Publication
(10) Pub. No.: US 2012/0185433 A1
(43) Pub. Date: Jul. 19, 2012

(54) PRIORITY-BASED ASYNCHRONOUS DATA REPLICATION

(75) Inventors: Theodore T. Harris, JR., Tucson, AZ (US); Jason L. Peipelman, Vail, AZ (US); Joshua M. Rhoades, Idaho Falls, ID (US); Matthew J. Ward, Vail, AZ (US)

(73) Assignee: INTERNATIONAL BUSINESS MACHINES CORPORATION, Armonk, NY (US)

(21) Appl. No.: 13/007,406

(22) Filed: Jan. 14, 2011

(51) Int. Cl. G06F 17/30

(52) U.S. Cl. 707/623; 707/E17.005

(57) ABSTRACT

A priority-based method for replicating data is disclosed herein. In one embodiment, such a method includes providing a primary storage device and a secondary storage device. Multiple storage areas (e.g., volumes, groups of volumes, etc.) are designated for replication from the primary storage device to the secondary storage device. A priority level is assigned to each of the storage areas. Using these priority levels, the method replicates the storage areas from the primary storage device to the secondary storage device in accordance with their assigned priority levels. Higher priority storage areas are replicated prior to lower priority storage areas. A corresponding computer program product and system are also disclosed herein.

### BACKGROUND

1. Field of the Invention

This invention relates to systems and methods for replicating data for disaster recovery and business continuity.

2. Background of the Invention

Data is increasingly one of an organization's most valuable assets. Accordingly, it is paramount that an organization regularly back up its data, particularly its business-critical data. Statistics show that a high percentage of organizations, as high as fifty percent, are unable to recover from an event of significant data loss, regardless of whether the loss is the result of a virus, data corruption, physical disaster, software or hardware failure, human error, or the like. At the very least, significant data loss can result in lost income, missed business opportunities, and/or substantial legal liability. Accordingly, it is important that an organization implement adequate backup policies and procedures to prevent such losses from occurring.

Various approaches currently exist for replicating data between storage devices. Once approach is to replicate data across geographically diverse areas (e.g., on the order of hundreds or thousands of miles apart) to ensure that data can survive a significant event or disaster, such as a hurricane, terrorist attack, or the like. This may also allow redundant storage devices to be placed on different power grids to ensure that data is always available. Because replicating data over long distances can introduce significant latency into the replication process, replicating data in this manner is typically performed asynchronously. This means that a write acknowledgment is typically sent to a host device when data is written to a local storage device without waiting for it to be replicated to a remote storage device. The data may then be transmitted across a WAN or other network and replicated to the remote storage device as time and bandwidth allow.

Unfortunately, asynchronous data replication systems typically replicate data to a remote site without taking into account the importance of the data. For example, business-critical data may be replicated to the remote site along with less critical data without considering the value of the data or giving priority to either type of data. This inability to distinguish between different values of data can lead to inefficient resource utilization.

In view of the foregoing, what are needed are systems and methods to prioritize data that is asynchronously replicated between storage devices. Ideally, such systems and method would be able to dedicate more resources (e.g., ports, communications paths, etc.) to the replication of more critical data, and fewer resources to the replication of less critical data. Such systems and methods would ideally provide a superior recovery point objective (RPO) time for more critical data.

### SUMMARY

The invention has been developed in response to the present state of the art and, in particular, in response to the problems and needs in the art that have not yet been fully solved by currently available systems and methods. Accordingly, the invention has been developed to provide systems and methods for replicating data across storage devices based on priority. The features and advantages of the invention will become more fully apparent from the following description and appended claims, or may be learned by practice of the invention as set forth hereinafter.

Consistent with the foregoing, a priority-based method for replicating data is disclosed herein. In one embodiment, such a method includes providing a primary storage device and a secondary storage device. Multiple storage areas (e.g., volumes, groups of volumes, etc.) are designated for replication from the primary storage device to the secondary storage device. A priority level is assigned to each of the storage areas. Using these priority levels, the method replicates the storage areas from the primary storage device to the secondary storage device in accordance with their assigned priority levels. Higher priority storage areas are replicated prior to lower priority storage areas.

A corresponding computer program product and system are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of an asynchronous data replication system;

FIG. 2 is a high-level block diagram showing one example of an asynchronous data replication system comprising a single primary storage device and a single secondary storage device;

FIG. 3 is a high-level block diagram showing one example of an asynchronous data replication system comprising multiple primary storage devices and multiple secondary storage devices;

FIG. 4 is a high-level block diagram showing one embodiment of an interface module for setting priority levels for storage areas;

FIG. 5 is a high-level block diagram showing one embodiment of a priority-based replication module; and

FIG. 6 is a high-level block diagram showing one embodiment of a storage device for use as a primary or secondary storage device.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As will be appreciated by one skilled in the art, the present invention may be embodied as an apparatus, system, method, or computer program product. Furthermore, the present invention may take the form of a hardware embodiment, a software embodiment (including firmware, resident software, microcode, etc.) configured to operate hardware, or an embodiment combining software and hardware aspects that may all generally be referred to herein as a “module” or “system.” Furthermore, the present invention may take the form of a computer-usable storage medium embodied in any tangible medium of expression having computer-usable program code stored therein.

Any combination of one or more computer-usable or computer-readable storage medium(s) may be utilized to store the computer program product. The computer-usable or computer-readable storage medium may be, for example but not limited to, an electronic, magnetic, optical, electromagnetic, infrared, or semiconductor system, apparatus, or device. More specific examples (a non-exhaustive list) of the computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, or a magnetic storage device. In the context of this document, a computer-usable or computer-readable storage medium may be any medium that can contain, store, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like, and conventional procedural programming languages, such as the “C” programming language or similar programming languages. Computer program code for implementing the invention may also be written in a low-level programming language such as assembly language.

The present invention may be described below with reference to flowchart illustrations and/or block diagrams of methods, apparatus, systems, and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

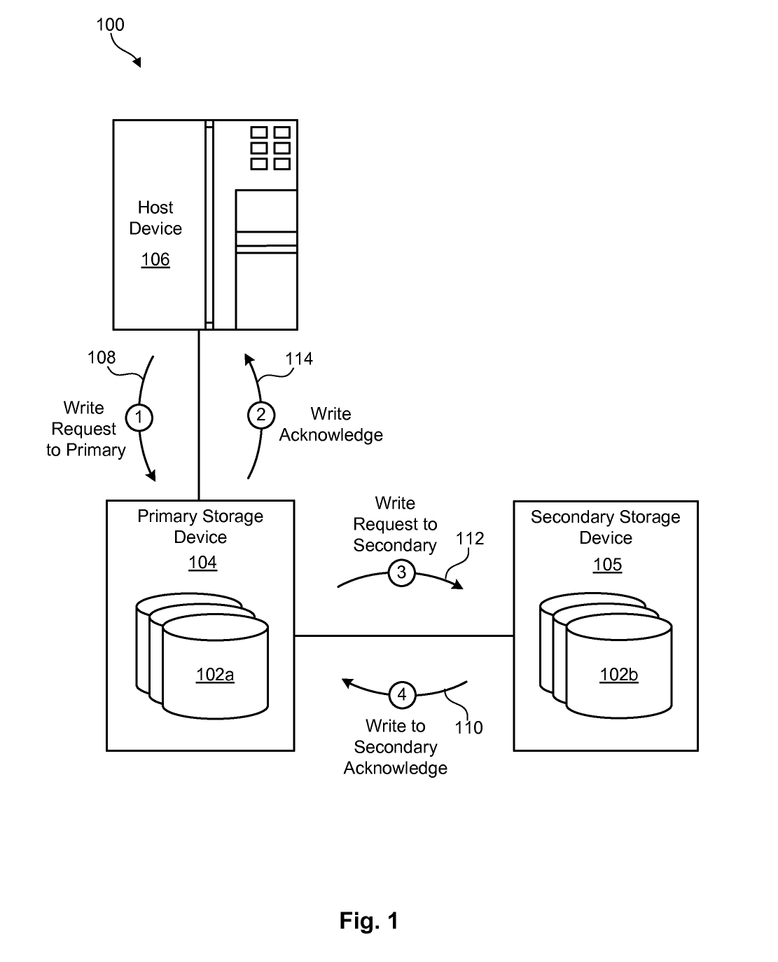

Referring to FIG. 1, one embodiment of an asynchronous data replication system 100 is shown. The asynchronous data replication system 100 is presented to show one example of an environment in which a priority-based method may operate and is not intended to be limiting. In general, the asynchronous data replication system 100 may be used to establish a mirroring relationship between one or more storage areas 102a (e.g., volumes or groups of volumes) on a primary storage device 104 and one or more storage areas 102b (e.g., volumes or groups of volumes) on a secondary storage device 105. The primary and secondary storage devices 104, 105 may be located a significant distance from one another (e.g., on the order of hundreds or thousands or miles apart) although this is not always necessary. Channel extension equipment may be located between the storage devices 104, 105, as needed, to extend the distance over which the storage devices 104, 105 may communicate.

As mentioned herein, the data replication system 100 may be configured to operate in an asynchronous manner, meaning that a write acknowledgment may be sent to a host device 106 when data is written to a local storage device 104 without waiting for the data to be replicated to a remote storage device 105. The data may be transmitted and written to the remote storage device 105 as time and bandwidth allow.

For example, in such a configuration a host device 106 may initially send a write request 108 to the primary storage device 104. This write operation 108 may be performed on the primary storage device 104 and the primary storage device 104 may then send an acknowledgement 114 to the host device 106 indicating that the write completed successfully. As time and bandwidth allow, the primary storage device 104 may then transmit a write request 112 to the secondary storage device 105 to replicate the data thereto. The secondary storage device 105 may execute the write operation 112 and return a write acknowledgement 110 to the primary storage device 104 indicating that the write completed successfully on the secondary storage device 105. Thus, in an asynchronous data replication system 100, the write only needs to be performed on the primary storage device 104 before an acknowledgement 114 is sent to the host 106.

Unfortunately, conventional asynchronous data replication systems 100 replicate data to remote storage devices 105 without taking into account the importance or priority of the data being replicated. For example, business-critical data may be replicated to a remote storage device 105 along with less critical data without considering the importance of the data. This inability to distinguish between different types of data can lead to inefficient resource utilization, as resources (e.g., ports, communication paths, etc.) may be allocated equally to data regardless of its importance.

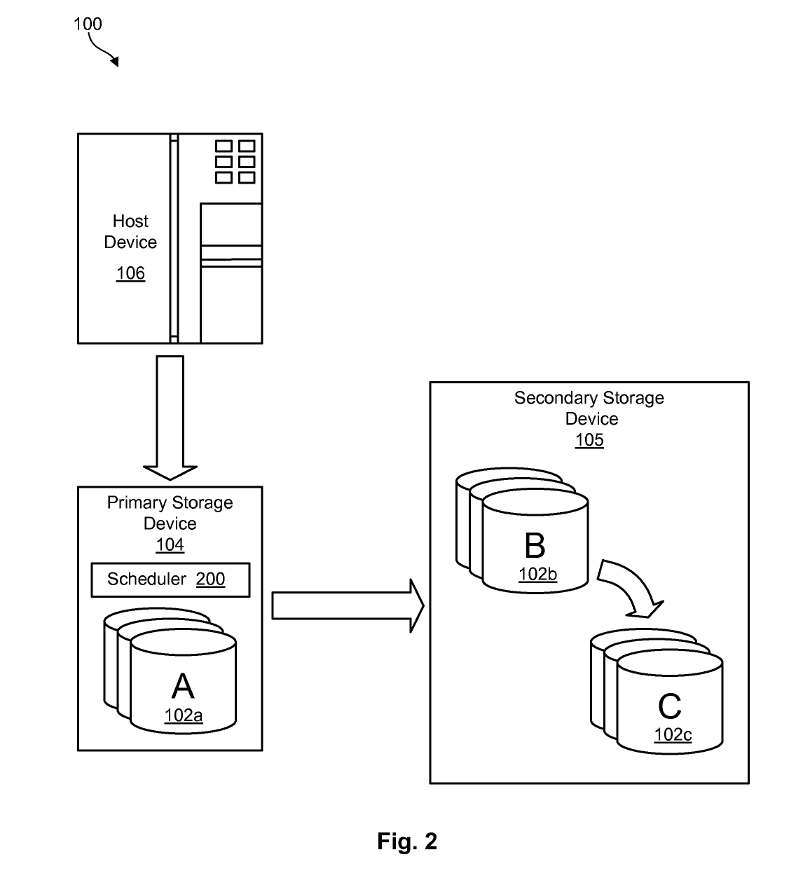

Referring to FIG. 2, a more particular embodiment of an asynchronous data replication system 100 is illustrated. The data replication system 100 illustrated in FIG. 2 is intended to describe the function of IBM's Global Mirror (Asynchronous PPRC) data replication system 100. Nevertheless, the apparatus and methods discussed herein are not limited to IBM's Global Mirror data replication system 100, but may be applicable to a variety of different asynchronous data replication systems 100 whether produced by IBM or other vendors.

In Global Mirror architectures, volumes 102a are grouped into a consistent session (also referred to as a “consistency group”) at the primary storage device 104. Point-in-time copies (i.e., “snapshots”) of these volumes 102a are generated at periodic intervals without impacting I/O to the volumes 102a. Once a point-in-time copy is generated, the copy is replicated to a secondary storage device 105. This will create a consistent copy 102b of the volumes 102a on the secondary storage device 105. Once the consistent copy 102b is generated, the primary storage device 104 issues a command to the secondary storage device 105 to save the consistent copy 102b. This may be accomplished by generating a point-in-time copy 102c of the consistent copy 102b using a feature such as IBM's FlashCopy feature.

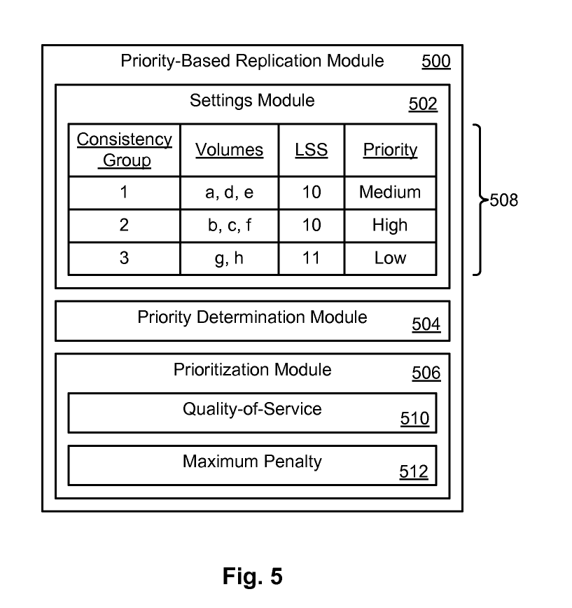

In Global Mirror architectures, a scheduler 200 is provided in the primary storage device 104 to schedule data replication from the primary storage device 104 to the secondary storage device 105. In conventional Global Mirror architectures, the scheduler 200 selects volumes 102a to replicate to the secondary storage device 105 on a first-in-first-out basis. That is, the first volume 102a for which a copy request is received is the first volume 102a that is allocated resources (e.g., ports, communication paths, etc.) for replication to the secondary storage device 105. This method of replication does not consider the importance of the data being replicated. As will be discussed in association with FIG. 5, in certain embodiments, the scheduler 200 may be configured to consider the importance of data when performing replication such that the data is not simply replicated on a first-in-first-out basis.

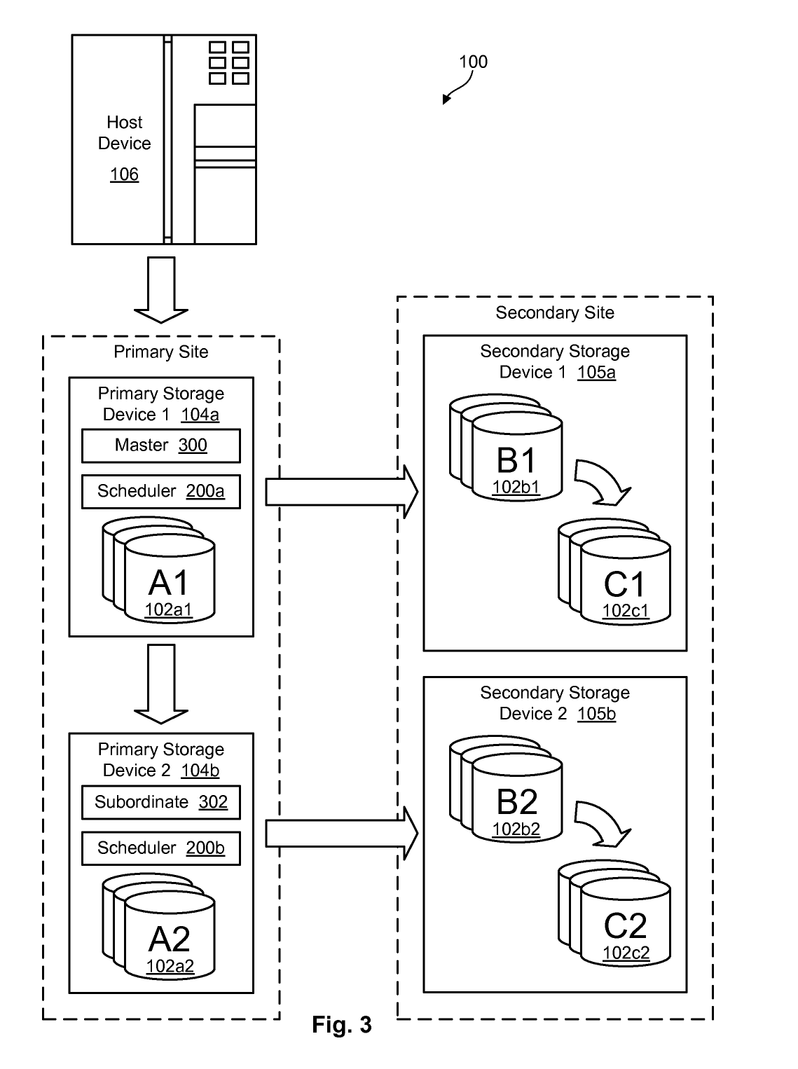

Referring to FIG. 3, in certain Global Mirror architectures, multiple primary storage devices 104a, 104b may be provided at a primary site. In such cases, a consistency group 102a1, 102a2 may be spread across multiple primary storage devices 104a, 104b. In Global Mirror architectures, one or more controlling functions, known as “masters,” may run on a primary storage device 104a. Each master 300 may control the creation of a consistency group and manage the replication of the consistency group across storage devices 104a, 104b, 105a, 105b. Each master may communicate with one or more “subordinates” in other primary storage devices 104b. In Global Mirror architectures, a “subordinate” 302 is a function inside a primary storage device 104b that is controlled by a master 300.

For example, when replicating a consistency group 102a1, 102a2 on one or more primary storage devices 104a, 104b to one or more secondary storage devices 105a, 105b, the master 300 associated with the consistency group 102a1, 102a2 controls the subordinate 302. That is, the master 300 controls the replication of the local volumes 102a1 to the secondary storage device 105a, as well as issues commands to subordinates 302 on other primary storage devices 104b, thereby instructing the subordinates 302 to replicate volumes 102a2 to one or more secondary storage devices 105b. The master 300 may also issue commands to the secondary storage device 105a to generate a point-in-time copy 102c1 of the replicated copy 102b1, using a feature such as FlashCopy. Similarly, the master 300 sends commands to subordinates 302 instructing the subordinates 302 to issue point-in-time copy commands (e.g., FlashCopy commands) to their respective secondary storage devices 105b. This will cause the secondary storage devices 105b to generate point-in-time copies 102c2 of their replicated copies 102b2. In this way, a master 300 is able to control the replication of a consistency group 102a1, 102a2 from multiple primary storage devices 104a, 104b to multiple secondary storage devices 105a, 105b.

In conventional Global Mirror architectures, communications that are sent from masters 300 to subordinates 302 do not take into account the importance of data associated with the masters 300. For example, one master 300 may manage a consistency group containing business-critical data while another master 300 may manage a consistency group containing less critical data. This importance is not taken into account when allocating resources and transmitting commands between masters 300 and subordinates 302. As will be explained in more detail hereafter, in certain embodiments, a data replication system 100 in accordance with the invention may be configured such that communications (e.g., commands, etc.) between masters 300 and subordinates 320 consider the importance of data associated with the communications.

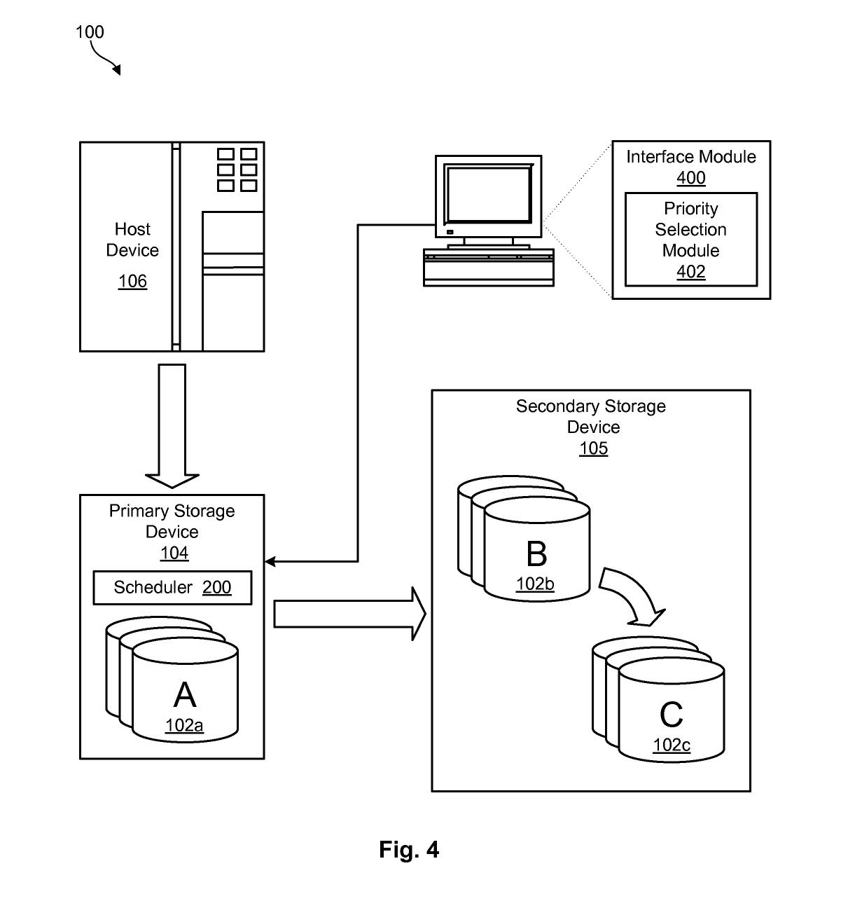

Referring to FIG. 4, in selected embodiments, an interface module 400 may be provided to enable a user to establish a priority for consistency groups or masters associated with consistency groups. More specifically, the interface module 400 may include a priority selection module 402 to enable the user to assign priority levels to consistency groups. In selected embodiments, these priority levels are assigned to consistency groups directly, masters associated with particular consistency groups, applications associated with particular consistency groups, or the like. The end result is that some consistency groups will be assigned higher priority levels than other consistency groups. This will allow consistency groups of differing priority levels to be treated differently when replicating data from primary storage devices 104 to secondary storage devices 105, or when sending communications from masters 300 to subordinates 302. In selected embodiments, the priority levels are assigned based on the importance of the data contained therein. For example, a higher priority level may be assigned to consistency groups containing more critical data while a lower priority level may be assigned to consistency groups containing less critical data. In general, I/O associated with higher priority consistency groups will be given preference over I/O associated with lower priority consistency groups. Accordingly, resources such as ports and communication paths will be allocated first to communications associated with higher priority consistency groups and then to communications associated with lower priority consistency groups.

Various methods and techniques may be used to establish priority levels for consistency groups. For example, the “mkgmir” command is a command that is used to create masters 300 in Global Mirror architectures. In selected embodiments in accordance with the invention, the “mkgmir” command may be modified or extended so that priority information can be assigned to a Global Mirror master. For example, the following statements could be typed into a command line interface (CLI) to create a master with a desired priority level:
mkgmir-session 25-lss 10-priority high
mkgmir-session 26-lss 10-priority low
   where the “session” field identifies the consistency group associated with the master, the “lss” field identifies the logical subsystem associated with the master, and the “priority” field identifies the priority level assigned to the master. In the above example, a user may select a priority level of either “high,” “medium,” or “low.” Other classifications are also possible. For example, in certain embodiments, the following statements could be typed into a command line interface (CLI) to assign a priority level between 1 and 10:
mkgmir-session 25-lss 10-priority 3
mkgmir-session 26-lss 10-priority 10
mkgmir-session 27-lss 10-priority 5

The commands illustrated above represent just a few examples of methods and techniques for assigning priority levels to masters. Any number of other methods or techniques may be used to assign priority levels to consistency groups, masters associated with consistency groups, applications associated with consistency groups, or the like. These priority levels could be assigned using a command line interface or other suitable graphical user interface.

Referring to FIG. 5, in selected embodiments, a priority-based replication module 500 may be incorporated into a data replication system 100. The priority-based replication module 500 may utilize the priority information to replicate data from primary storage devices 104 to secondary storage devices 105, or send commands between masters 300 and subordinates 302. Such a priority-based replication module 500 may include one or more of a settings module 502, a priority determination module 504, and a prioritization module 506. These modules may be implemented in hardware, software or firmware executable on hardware, or a combination thereof. These modules are presented only by way of example and are not intended to be limiting. Indeed, alternative embodiments may include more or fewer modules than those illustrated. It should also be recognized that, in some embodiments, the functionality of some modules may be broken into multiple modules or, conversely, the functionality of several modules may be combined into a single module or fewer modules.

As shown, the settings module 502 keeps track of the priority levels assigned to different consistency groups on a data replication system 100. As mentioned previously, in certain embodiments, a user may initially establish these priority levels by way of an interface module 400. These priority levels may then be stored by the settings module 502 using any suitable technique. For example, the settings module 502 could keep track of these values in a table 508. As shown, the table 508 identifies consistency groups, volumes associated with the consistency groups, the LSSs (logical subsystems) assigned to the consistency groups, and priority levels assigned to the consistency groups. This table 508 is presented only be way of example and is not intended to be limiting. Other methods for storing priority information associated with consistency groups are possible and within the scope of the invention.

The priority determination module 504 may be used to determine the priority level of data when replicating data from a primary storage device 104 to secondary storage device 105, or when sending commands between masters 300 and subordinates 302. For example, if several consistency groups are in line to be replicated from a primary storage device 104 to secondary storage device 105, the priority determination module 504 may determine the priority level for each consistency group. In certain embodiments, this may be accomplished by reading a table 508 or other data structure containing the desired priority information.

Once the priority level of each consistency group is determined, the prioritization module 506 prioritizes (i.e., orders) the replication of the data. For example, consistency groups with higher priority levels will be allocated resources (e.g., ports, communication paths, etc.) and replicated prior to consistency groups with lower priority levels. In doing so, the prioritization module 506 may consider a quality-of-service 510 and maximum penalty 512 for all consistency groups. This may prevent consistency groups with higher priority levels from starving consistency groups with lower priority levels from getting necessary resources. Thus, while giving higher priority consistency groups higher priority in terms of resources and bandwidth, the prioritization module 506 may also ensure that some specified quality-of-service 510 is maintained for lower priority consistency groups, and/or ensure the performance of lower priority consistency groups is not impacted beyond some maximum penalty 512. As a simple example, the prioritization module 506 could allocate 60 percent of the bandwidth and resources to high-priority consistency groups, 30 percent of the bandwidth and resources to medium-priority consistency groups, and 10 percent of the bandwidth and resources to low-priority consistency groups. This will ensure that low-priority consistency groups will receive some specified allocation of resources and bandwidth to prevent starvation.

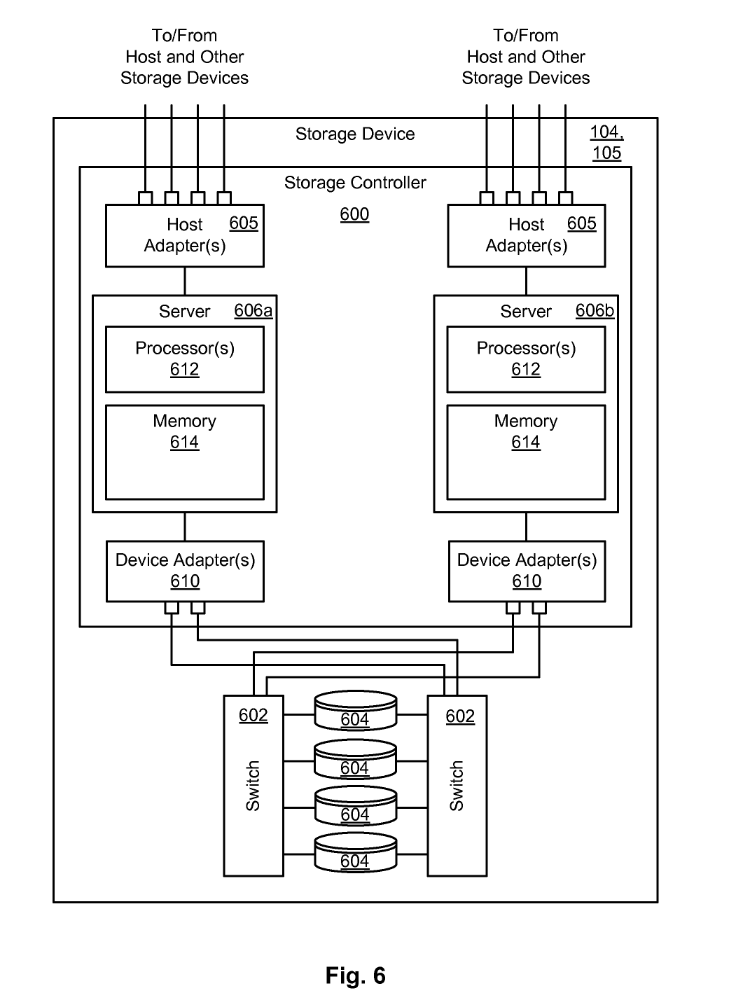

Referring to FIG. 6, one embodiment of a storage device 104, 105 (such as a primary or secondary storage device 104, 105) is illustrated. Such a storage device 104, 105 may host the priority-based replication module 500 described in FIG. 5. This storage device 104, 105 is provided only by way of example and is not intended to be limiting. In this example, the storage device 104, 105 contains an array of hard-disk drives 604 and/or solid-state drives 604. As shown, the storage device 104, 105 includes a storage controller 600, one or more switches 602, and storage media 604, which includes the hard-disk drives 604 or solid-state drives 604. The storage controller 600 may enable one or more hosts 106 (e.g., open system and/or mainframe servers 106) or other storage devices to access data in the storage media 604.

In selected embodiments, the storage controller 600 includes one or more servers 606. The storage controller 600 may also include host adapters 605 to connect the storage device 104, 105 to host devices 106 and other storage devices, and device adapters 610 to connect to the storage media 604. Multiple servers 606a, 606b may provide redundancy to ensure that data is always available to connected hosts. Under normal operating conditions, the servers 606a, 606b may share the I/O load. For example, one server 606a may handle I/O for volumes associated with even logical subsystems (LSSs), while the other server 606b may handle I/O for volumes associated with odd logical subsystems (LSSs). If one server 606a fails, the other server 606b may pick up the I/O load of the failed server 606a to ensure that I/O is able to continue to all volumes. This process may be referred to as a “failover.”

In selected embodiments, each server 606 includes one or more processors 612 (e.g., n-way symmetric multiprocessors) and memory 614. The memory 614 may include volatile memory (e.g., RAM) as well as non-volatile memory (e.g., ROM, EPROM, EEPROM, hard disks, flash memory, etc.). The memory 614 may store software modules that run on the processor(s) 612 and are used to access data in the storage media 604. The servers 606 may host at least one instance of these software modules, which collectively may be referred to as a “server,” albeit in software form. These software modules may manage all read and write requests to logical volumes in the storage media 604.

One example of a storage device 104, 105 having an architecture similar to that illustrated in FIG. 6 is the IBM DS8000™ enterprise storage system. Nevertheless, embodiments of the invention are not limited to implementation in the IBM DS8000™ enterprise storage system, but may be implemented in any comparable or analogous storage device 104, 105, regardless of the manufacturer, product name, or components or component names associated with the system. Furthermore, any storage device that could benefit from one or more embodiments of the invention is deemed to fall within the scope of the invention. Thus, the IBM DS8000™ is presented only by way of example and is not intended to be limiting.

The flowcharts and block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for replicating data, the method comprising;
providing a primary storage device and a secondary storage device;
designating a plurality of storage areas for replication from the primary storage device to the secondary storage device;
assigning a priority level to each of the storage areas; and
replicating the storage areas from the primary storage device to the secondary storage device in accordance with their assigned priority levels, wherein higher priority storage areas are replicated prior to lower priority storage areas.

2. The method of claim 1, wherein the storage areas comprise one of volumes and groups of volumes.

3. The method of claim 1, further comprising maintaining a designated quality-of-service when replicating each storage area.

4. The method of claim 1, further comprising designating a maximum penalty associated with replicating each storage area.

5. The method of claim 1, wherein assigning the priority level to each of the storage areas comprises assigning the priority level to an application associated with each of the storage areas.

6. The method of claim 1, wherein each storage area is associated with a “master” running on the primary storage device, wherein the master is configured to communicate with at least one “subordinate” running on other primary storage devices.

7. The method of claim 6, wherein assigning the priority level to each of the storage areas comprises assigning the priority level to a master associated with each of the storage areas.

8. The method of claim 7, further comprising prioritizing communications between masters and subordinates based on the priority level assigned to the masters.

9. A computer program product for replicating data between a primary storage device and a secondary storage device, the computer program product comprising a computer-usable storage medium having computer-usable program code embodied therein, the computer-usable program code comprising:
computer-usable program code to designate a plurality of storage areas for replication from a primary storage device to a secondary storage device;
computer-usable program code to assign a priority level to each of the storage areas; and
computer-usable program code to replicate the storage areas from the primary storage device to the secondary storage device in accordance with their assigned priority levels, wherein higher priority storage areas are replicated prior to lower priority storage areas.

10. The computer program product of claim 9, wherein the storage areas comprise one of volumes and groups of volumes.

11. The computer program product of claim 9, further comprising computer-usable program code to maintain a designated quality-of-service when replicating each storage area.

12. The computer program product of claim 9, further comprising computer-usable program code to designate a maximum penalty associated with replicating each storage area.

13. The computer program product of claim 9, wherein assigning the priority level to each of the storage areas comprises assigning the priority level to an application associated with each of the storage areas.

14. The computer program product of claim 9, wherein each storage area is associated with a “master” running on the primary storage device, wherein the master is configured to communicate with at least one “subordinate” running on other primary storage devices.

15. The computer program product of claim 14, wherein assigning the priority level to each of the storage areas comprises assigning the priority level to a master associated with each of the storage areas.

16. The computer program product of claim 15, further comprising computer-usable program code to prioritize communications between masters and subordinates based on the priority level assigned to the masters.

17. A system for replicating data between a primary storage device and a secondary storage device, the system comprising:
a secondary storage device;
a primary storage device comprising a plurality of storage areas for replication to the secondary storage device, each storage area having a priority level assigned thereto; and
the primary storage device further configured to replicate the storage areas to the secondary storage device in accordance with their assigned priority levels, wherein higher priority storage areas are replicated prior to lower priority storage areas.

18. The system of claim 17, wherein each storage area is associated with a “master” running on the primary storage device, wherein the master is configured to communicate with at least one “subordinate” running on other primary storage devices.

19. The system of claim 18, wherein each master has a priority level assigned thereto.

20. The system of claim 19, wherein the primary storage device is configured to prioritize communications between masters and subordinates based on the priority level assigned to the masters.
